(19) United States
(12) Patent Application Publication
(10) Pub. No.: US 2025/0252353 A1
(43) Pub. Date: Aug. 7, 2025

(54) METHOD OF TRAINING MONOTONIC MULTI-LABEL CLASSIFICATION MODEL TO IMPROVE PERFORMANCE OF EMERGENCY REPORT ANALYSIS

(71) Applicant: ELECTRONICS AND TELECOMMUNICATIONS RESEARCH INSTITUTE, Daejeon (KR)

(72) Inventors: Eun Gyeol LEE, Daejeon (KR); Hyunho Park, Daejeon (KR); Eun Jung Kwon, Daejeon (KR); Young Soo Park, Daejeon (KR); SungWon Byon, Daejeon (KR); Minjung Lee, Daejeon (KR); Eui Suk Jung, Daejeon (KR)

(21) Appl. No.: 19/045,751

(22) Filed: Feb. 5, 2025

(30) Foreign Application Priority Data
Feb. 7, 2024 (KR) 10-2024-0019195
Jan. 15, 2025 (KR) 10-2025-0006150

(51) Int. Cl. G06N 20/00

(52) U.S. Cl. CPC G06N 20/00

(57) ABSTRACT

Provided is a method of training a monotonic multi-label classification model for improving the performance of emergency report analysis. The method includes inputting training data into a monotonic multi-label classification model based on a machine learning model to generate a prediction probability matrix for each of preset monotonic multi-labels, inputting a target value matrix corresponding to the training data and the prediction probability matrix into a predetermined distance loss function to calculate a loss, and training the monotonic multi-label classification model based on the loss.

### CROSS-REFERENCE TO RELATED APPLICATIONS

This application claims priority under 35 U.S.C. § 119 to Korean Patent Application Nos. 10-2024-0019195, filed on Feb. 7, 2024, and 10-2025-0006150, Jan. 15, 2025, the disclosure of which is incorporated herein by reference in its entirety.

### BACKGROUND

### 1. Field

The present invention relates to a method of training a machine learning model for classifying a monotonic label, such as the level of urgency, using a loss function, and a system for performing the method.

### 2. Discussion of Related Art

Emergency reports (e.g., crime reports, disaster reports) are reports submitted by witnesses or individuals involved in incidents or accidents, and require a prompt response from relevant agencies. Relevant agencies, such as the police or fire department, are urgently dispatched to respond to incidents or accidents based on the content of the emergency report provided by the reporter. For example, crime reports to the police (e.g., 112 in Korea) may be made by phone calls, text messages, or smartphone apps, and emergency dispatch is performed based on the severity of the report.

Table 1 shows examples of emergency call numbers by country (Source: https://en.wikipedia.org/wiki/List_of_emergency telephone_numbers).

In this specification, emergency reports to the police, ambulance, fire department, and the like are collectively referred to as “emergency reports.”

TABLE

| | | | |
|---|---|---|---|
| Country | Police | Ambulance | Fire |

| | | |
|---|---|---|
| Korea | 112 | 119 |

| USA | 911 | | |
|---|---|---|---|
| China | 110 | 120 | 119 |

| | | |
|---|---|---|
| Japan | 110 | 119 |

| UK | 999 or 112 | | |
|---|---|---|---|
| France | 112 or 17 | 112 or 15 | 112 or 18 |

| | | |
|---|---|---|
| Germany | 110 | 112 |

When the police or fire department receives an emergency report, they determine whether to dispatch based on the need for emergency handling. Using a classifier based on a machine learning model, the level of urgency may be automatically determined based on the content of the emergency report, and whether dispatch is needed may be determined based on the level of urgency. Since the level of urgency corresponds to a monotonic label with a stepwise size, a decision tree model or an artificial neural network model capable of monotonic label classification may be used as a classifier for determining the level of urgency.

For example, when an artificial neural network model is used as a classifier for determining the level of urgency, the performance of the classifier for analyzing emergency reports varies depending on training conditions, such as a model architecture, an optimizer, a learning rate, and a loss function. With regard to the loss function among the training conditions, conventional classifiers have used loss functions, such as mean square error or cross-entropy, but these loss functions may not be considered a loss function suitable for monotonic label classification.

### SUMMARY OF THE INVENTION

The present invention is directed to providing a method of training a multi-label classification model based on a machine learning model using a distance loss function suitable for monotonic label classification, such as classification of the level of urgency, and a system capable of performing the method.

The technical objectives of the present invention are not limited to the above, and other objectives may become apparent to those of ordinary skill in the art based on the following description.

According to an aspect of the present invention, there is provided a method of training a monotonic multi-label classification model, which includes: receiving, by a computer system including a memory in which computer-readable instructions are stored and at least one processor that is implemented to execute the instructions, training data; inputting, by the computer system, the training data into a monotonic multi-label classification model based on a machine learning model to generate a prediction probability matrix for each of preset monotonic multi-labels; inputting, by the computer system, a target value matrix corresponding to the training data and the prediction probability matrix into a predetermined distance loss function to calculate a loss; and training, by the computer system, the monotonic multi-label classification model based on the loss.

According to an aspect of the present invention, there is provided a computer system including a memory in which computer-readable instructions are stored; and at least one processor implemented to execute the instructions.

The at least one processor is configured to execute the instructions to: input training data into a monotonic multi-label classification model based on a machine learning model to generate a prediction probability matrix for each of preset monotonic multi-labels; input a target value matrix corresponding to the training data and the prediction probability matrix into a predetermined distance loss function to calculate a loss; and train the monotonic multi-label classification model based on the loss.

The distance loss function used in the method of training a monotonic multi-label classification model or used by the computer system generates a weight to be multiplied by an error based on a distance between a target label extracted from the target value matrix and an index of the monotonic multi-label.

The distance loss function is defined by the following equation:

$$L = \frac{1}{n l} {\sum }_{i = 1}^{n} {\sum }_{j = 1}^{l} {( \vert A ( {T}_{i} ) - j \vert + 1 )}^{2} {( {T}_{i j} - {Y}_{i j} )}^{2} , \qquad [ Equation ]$$

$$A ( {T}_{i} ) = {argmax}_{k} {T}_{i k} = \{ k \vert {T}_{i k} = {max}_{1 \leq {k}^{′} \leq l} {T}_{{ik}^{′}} \}$$

wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

In addition, the distance loss function is defined by the following equation:

$$L = \frac{1}{n l} {\sum }_{i = 1}^{n} {\sum }_{j = 1}^{l} ( \vert A ( {T}_{i} ) - j \vert + 1 ) {( {T}_{i j} - {Y}_{i j} )}^{2} , \qquad [ Equation ]$$

$$A ( {T}_{i} ) = {argmax}_{k} {T}_{i k} = \{ k \vert {T}_{i k} = {max}_{1 \leq {k}^{′} \leq l} {T}_{{ik}^{′}} \}$$

wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

In addition, the distance loss function is defined by the following equation:

$$L = \frac{1}{n l} {\sum }_{i = 1}^{n} {\sum }_{j = 1}^{l} {( \vert A ( {T}_{i} ) - j \vert + 1 )}^{2} \times \vert {T}_{i j} - {Y}_{i j} \vert , \qquad [ Equation ]$$

$$A ( {T}_{i} ) = {argmax}_{k} {T}_{i k} = \{ k \vert {T}_{i k} = {max}_{1 \leq {k}^{′} \leq l} {T}_{{ik}^{′}} \}$$

wherein, In the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

In addition, the distance loss function is defined by the following equation:

$$L = \frac{1}{n l} {\sum }_{i = 1}^{n} {\sum }_{j = 1}^{l} ( \vert A ( {T}_{i} ) - j \vert + 1 ) \times \vert {T}_{i j} - {Y}_{i j} \vert , \qquad [ Equation ]$$

$$A ( {T}_{i} ) = {arg max}_{k} {T}_{i k} = \{ k \vert {T}_{i k} = {max}_{1 \leq {k}^{′} \leq l} {T}_{{ik}^{′}} \}$$

wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating the configuration of a monotonic multi-label classification model according to an embodiment of the present invention;

FIG. 2 is a block diagram illustrating a computer system for implementing a method of training a monotonic multi-label classification model according to an embodiment of the present invention; and

FIG. 3 is a flowchart for describing a method of training a monotonic multi-label classification model according to an embodiment of the present invention.

### DETAILED DESCRIPTION OF EXEMPLARY EMBODIMENTS

The advantages and features of the present invention and ways of achieving them will become readily apparent with reference to the detailed description of the following embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

It should be understood that, although the terms “first,” “second,” etc. may be used herein to describe various elements, these elements are not limited by these terms. These terms are only used for distinguishing one element from another. For example, a first element could be called a second element and a second element could be called a first element without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the description of the present invention, when it is determined that a detailed description of related technology may unnecessarily obscure the gist of the present invention, the detailed description will be omitted.

Hereinafter, embodiments of the present invention will be described with reference to the accompanying drawings in detail. For better understanding of the present invention, the same reference numerals are used to refer to the same elements through the description of the drawings.

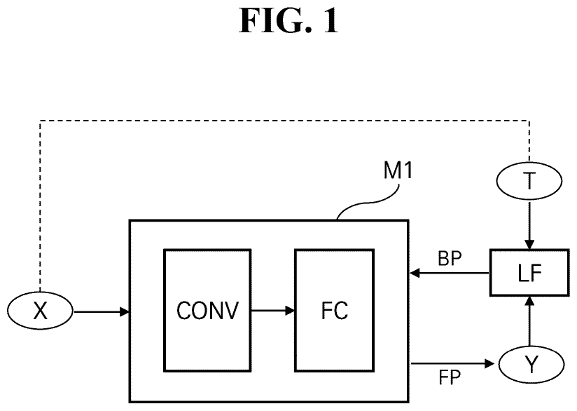

FIG. 1 is a block diagram illustrating the configuration of a monotonic multi-label classification model according to an embodiment of the present invention.

As illustrated in FIG. 1, a monotonic multi-label classification model (M1, hereinafter referred to as a “classification model”) according to the present invention may be a neural network model including a convolutional layer CONV and a fully-connected layer FC, or may include the neural network model.

A method of training a monotonic multi-label classification model according to an embodiment of the present invention (hereinafter referred to as a “classification model training method”) is performed by a computer system 100.

The computer system 100 inputs training data X into the classification model M1 and generates a predicted value Y through forward propagation FP passing through the convolutional layer CONV and fully-connected layer FC. In addition, the computer system 100 inputs the predicted value Y and a target value T corresponding to the training data X into a loss function LF to calculate a loss, and trains the classification model M1 through backpropagation BP based on the loss.

The classification model training method according to an embodiment of the present invention is characterized using a distance loss function L_{DIST} as the loss function LF.

The distance loss function L_{DIST} calculates the loss through a weighted sum of an error between the target value T corresponding to the training data X and the predicted value Y generated by the classification model M1. The distance loss function L_{DIST} is a loss function characterized by calculating a weight to be multiplied by the error based on the distance between a label corresponding to the target value T in multiple labels and each label included in the multiple labels. The target value T corresponds to a correct label of the training data X. When the training data X is provided in plural, the target value T may be expressed in the form of a target value matrix, and the predicted value Y may be expressed in the form of a predicted probability matrix. In the target value matrix and the predicted probability matrix, each row corresponds to an index i of the training data X, and each column corresponds to an index j of each label included in the monotonic multi-label.

In FIG. 1, the training data X may be emergency report information. In this case, the target value T corresponding to the training data X may be the level of urgency, which is a label with a stepwise size, or a matrix defined based on the degree of urgency. In other words, the target value T may be a monotonic multi-label.

For example, when the training data X is crime report information, the corresponding label, that is, the level of urgency, may have the form of an emergency code.

Table 2 shows an example of the level of urgency (an emergency code), a classification criterion (the definition of an emergency code), and a dispatch target time for crime report information. The urgency level in Table 2 is given as a monotonic multi-label (C0 to C4).

TABLE 2

| The level of | | |
|---|---|---|
| urgency (an | Classification criterion (the | |
| emergency | definition of an emergency | |
| code) | code) | Target dispatch time |
| C0 (Code 0) | moving crime | within the shortest |
| | violent crime (in-progress) | possible time |
| | example) a situation suspected | |
| | of a violent crime, such as a | |
| | woman screaming and then | |
| | being disconnected | |
| C1 (Code 1) | imminent or ongoing danger to | within the shortest |
| | life or body, or immediately | possible time |
| | after the danger has occurred | |
| | in-progress crime | |
| | example) a situation in which an | |
| | unknown person tries to open | |
| | the front door | |
| C2 (Code 2) | potential danger to life or body | dispatch within a range |
| | or crime prevention required | that does not interfere |
| | example) a situation in which a | with handling codes |
| | customer does not wake up even | 0 to 1 |
| | after his/her business is done | |
| C3 (Code 3) | immediate on-site action not | as a rule, an appointment |
| | required, but investigation or | is made with the reporter |
| | consultation required | to handle an incident |
| | example) a situation in which a | during working hours on |
| | gold ring has gone missing but | the same day, and the |
| | the time of the incident is | dispatch time is |
| | unknown | extendable up to |
| | | 12 hours. |
| C4 (Code 4) | non-urgent civil complaints or | no dispatch or transfer to |
| | consultation reports | another agency |

For example, assuming that the training data X is emergency report information and the corresponding label, that is, the levels of urgency (one of C0 to C4), are as shown in Table 3, the target value matrix T corresponding to the training data X may be defined as a matrix as shown in Equation 1. The rows of the target value matrix T represent data (emergency report information), and the columns represent the level of urgency. Since the level of urgency corresponding to X2 is C1, a factor T₂₂ of the target value matrix T becomes 1.

TABLE 3

| Training data X; Emergency | |
|---|---|
| reporting information | Level of urgency |
| X1 | C0 |
| X2 | C1 |
| X3 | C3 |

$$T = ( \begin{matrix}1 & 0 & 0 & 0 & 0 \\ 0 & 1 & 0 & 0 & 0 \\ 0 & 0 & 0 & 1 & 0\end{matrix} ) \qquad [ Equation 1 ]$$

When training a neural network model for multi-label classification, it is common to use a cross-entropy loss function. However, when labels have a monotonic feature, the cross-entropy loss function does not use the monotonic feature of the labels at all. To alleviate this limitation, more entropy needs to be applied to distant predictions than to close predictions. For example, the rating prediction model needs to apply more entropy to the loss function when predicting the target degree of urgency C0 to C4, compared to when predicting the target degree of urgency C0 or C1. This idea was developed by applying the existing weighted mean squared error loss function. The weighted mean squared error loss function may be defined as in Equation 2.

$${L}_{W M S E} = \frac{1}{n l} {\sum }_{i = 1}^{n} {\sum }_{j = 1}^{l} {{w}_{i} ( {T}_{i j} - {Y}_{i j} )}^{2}$$

In Equation 2, L_{WMSE} represents a weighted mean squared error loss function. i is an index of data, and n is the number of data. j is an index of a label, and 1 is the number of labels. Tᵢⱼ is a target value for a j^{th} label of i^{th} data, which is a prediction target of the classification model M1, and has a value of 0 or 1. Yᵢⱼ is a probability value predicted by the classification model M1 for the pair of i^{th} data and a j^{th} label, and is a real value greater than or equal to 0 and less than or equal to 1. wᵢ is a weight assigned to the i^{th} data.

The present invention newly proposes a method of using a distance loss function L_{DIST} for classification of monotonic labels with a stepwise size in training the classification model M1 to further improve the performance of a model that classifies monotonic labels by referring to the existing weighted mean squared error loss function L_{WMSE}.

Specifically, the present specification discloses, as distance loss functions L_{DIST}, 1) a distance mean square loss function L_{DiMS}, 2) an absolute distance mean square loss function L_{ADiMS}, 3) a distance mean absolute loss function L_{DiMA}, and 4) an absolute distance mean absolute loss function L_{ADiMA}.

The equation for the distance mean square loss function L_{DiMS} is shown in Equation 3. L_{DiMS} assigns weights based on the characteristics of weighted mean square error that may set each weight according to labels. That is, L_{DiMS} assigns a higher weight to the loss when the predicted value is far from the target value, and assigns a lower weight when the predicted value is close to the target value.

$${L}_{D i M S} = \frac{1}{n l} {\sum }_{i = 1}^{n} {\sum }_{j = 1}^{l} {( \vert A ( {T}_{i} ) - j \vert + 1 )}^{2} {( {T}_{i j} - {Y}_{i j} )}^{2}$$

$$herein , A ( {T}_{i} ) = {arg max}_{k} {T}_{ik} = \{ k \vert {T}_{ik} = {max}_{1 \leq {k}^{′} \leq l} {T}_{{ik}^{′}} \}$$

In Equation 3, as in Equation 2, 1 represents the number of monotonic multi-labels (hereinafter abbreviated as “labels'” and n represents the number of data. T represents a target value matrix (e.g., a two-dimensional matrix), and Y represents a predicted probability matrix (e.g., a two-dimensional matrix) calculated by the classification model M1. Tᵢⱼ represents a target value of the pair of i^{th} training data (hereinafter “data”), and a j^{th} label, which is a prediction target of the classification model M1, and has a value of 0 or 1. In addition, Yᵢⱼ represents a probability value predicted by the classification model M1 for the pair of the i^{th} data and the j^{th} label, and is a real value greater than or equal to 0 and less than or equal to 1. The weight wᵢⱼ=(|A(Tᵢ)−j|+1)² is a value that varies depending on the index of the training data (i, hereinafter referred to as a “data index”) and each index of the monotonic multi-labels (j, hereinafter referred to as “a label index”), and is obtained by squaring a value of |A(Tᵢ)−j|, which is the distance (an absolute value) between the target label A(Ti) and the label index j, plus 1. Function A is a function that obtains the value of a label corresponding to the largest value 1 in the target value vector Ti, i.e., the target label. Function A is a function that obtains an index with the maximum value (Arg max: the arguments of the maxima). In other words, the “A(Tᵢ)−j” part in Equation 3 represents the distance. The reason for squaring the value of the distance plus 1 is to assign the least weight to a value that has accurately predicted the target in the loss function to ensure that the classification model M1, which is a subject of training, produces a prediction probability close to the correct answer.

An example in which the loss is calculated using the distance mean square loss function L_{DiMS} is presented below.

Assume that a target value matrix T corresponding to training data X and a predicted probability matrix Y generated by the classification model M1 by receiving the training data X are as follows.

$$T = ( \begin{matrix}1 & 0 \\ 0 & 1\end{matrix} ) , Y = ( \begin{matrix}0.6 & 0.4 \\ 0.3 & 0.7\end{matrix} )$$

That is, the target values for each pair of data index i and label index j are T₁₁=1, T₁₂=0, T₂₁=0, and T₂₂=1, and the predicted probabilities for each pair of data index i and label index j are Y₁₁=0.6, Y₁₂=0.4, Y₂₁=0.3, and Y₂₂=0.7.

The target labels for individual training data X₁ and X₂ may be obtained through the function A. The target labels for individual training data X₁ and X₂ are A(T₁)=1 and A(T₂)=2.

Therefore, the distance mean square loss is calculated as follows according to Equation 3.

$${L}_{D i M S} = ( \frac{1}{n l} ) \times \{ {( \vert A ( {T}_{1} ) - 1 \vert + 1 )}^{2} {( {T}_{11} - {Y}_{11} )}^{2} + {( \vert A ( {T}_{1} ) - 2 \vert + 1 )}^{2} {( {T}_{12} - {Y}_{12} )}^{2} + {( \vert A ( {T}_{2} ) - 1 \vert + 1 )}^{2} {( {T}_{21} - {Y}_{21} )}^{2} + {( \vert A ( {T}_{2} ) - 2 \vert + 1 )}^{2} {( {T}_{22} - {Y}_{22} )}^{2} \} = 0.25 \times \{ {( \vert 1 - 1 \vert + 1 )}^{2} {( 1 - 0.6 )}^{2} + {( \vert 1 - 2 \vert + 1 )}^{2} {( 0 - 0.4 )}^{2} + {( \vert 2 - 1 \vert + 1 )}^{2} {( 0 - 0.3 )}^{2} + {( \vert 2 - 2 \vert + 1 )}^{2} {( 1 - 0.7 )}^{2} \} = 0.25 \times ( 1 \times 0.16 + 4 \times 0.16 + 4 \times 0.09 + 1 \times 0.09 ) = 0.25 \times 1.25 = 0.3125$$

Therefore, in the example, the distance mean square loss is 0.3125.

Meanwhile, as a modified embodiment of the distance mean square loss function L_{DiMS}, the absolute distance mean square loss function L_{ADiMS}, the distance mean absolute value loss function L_{DiMA}, and the absolute distance mean absolute value loss function L_{ADiMA} are presented as shown in Equations 4 to 6.

$${L}_{A D i M S} = \frac{1}{n l} {\sum }_{i = 1}^{n} {\sum }_{j = 1}^{l} ( \vert A ( {T}_{i} ) - j \vert + 1 ) {( {T}_{i j} - {Y}_{i j} )}^{2} \qquad [ Equation 4 ]$$

$${L}_{D i M A} = \frac{1}{n l} {\sum }_{i = 1}^{n} {\sum }_{j = 1}^{l} {( \vert A ( {T}_{i} ) - j \vert + 1 )}^{2} \times \vert {T}_{i j} - {Y}_{i j} \vert \qquad [ Equation 5 ]$$

$${L}_{A D i M A} = \frac{1}{n l} {\sum }_{i = 1}^{n} {\sum }_{j = 1}^{l} ( \vert A ( {T}_{i} ) - j \vert + 1 ) \times \vert {T}_{i j} - {Y}_{i j} \vert \qquad [ Equation 6 ]$$

Equations 4 to 6 are distance loss functions that have some differences from Equation 3. The configurations of the loss functions of Equations 3 to 6 are summarized in Table 4.

TABLE 4

| Loss function | Distance weight | Error |
|---|---|---|
| Distance mean square | square of absolute | squared error |
| loss function L_{DiMS} | distance between | (mean squared |
| | target label A(Ti) and | error) |
| | label index j + 1 | |
| Absolute distance mean | absolute distance | squared error |
| square loss function | between target label | (mean squared |
| L_{ADiMS} | A(Ti) and label index j + 1 | error) |
| Distance mean absolute | square of absolute | absolute error |
| loss function L_{DiMA} | distance between | (mean absolute |
| | target label A(Ti) and | error) |
| | label index j + 1 | |
| Absolute distance mean | absolute distance | absolute error |
| absolute loss function | between target label | (mean absolute |
| L_{ADiMA} | A(Ti) and label index j + 1 | error) |

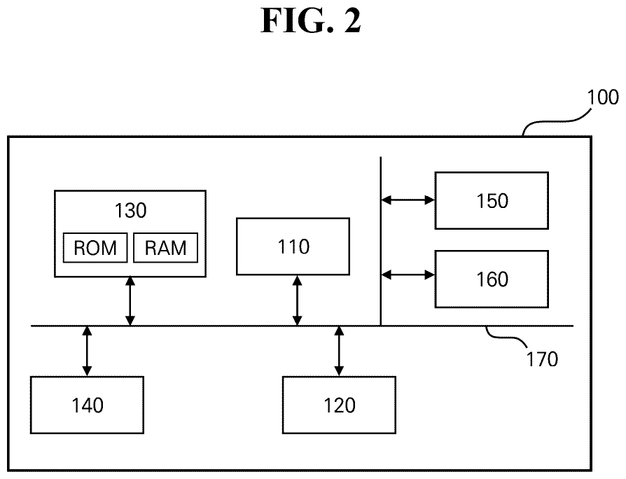

FIG. 2 is a block diagram illustrating a computer system for implementing a method (“a classification model training method”) of training a monotonic multi-label classification model according to an embodiment of the present invention.

Referring to FIG. 2, the computer system 100 may include at least one processor 110, a memory 130, an input interface device 150, an output interface device 160, and a storage device 140 that communicate through a bus 170. The computer system 100 may also further include a communication device 120 coupled to a network.

The computer system 100 shown in FIG. 2 is based on one embodiment, and components of the computer system 100 according to the present invention are not limited to those shown in FIG. 2, and some components may be added, changed, or omitted.

The processor 110 may be a central processing unit (CPU) or a semiconductor device that execute computer-readable instructions stored in the memory 130 and/or the storage device 140. The memory 130 and the storage device 140 may include various forms of volatile or nonvolatile media. For example, the memory 130 may include a read only memory (ROM) or a random access memory (RAM). In an embodiment of the present invention, the memory 130 may be located inside or outside the processor 110 and may be connected to the processor 110 through various known means. The memory 130 may include various forms of volatile or nonvolatile media, for example, may include a ROM or a RAM.

Accordingly, the embodiments of the present invention may be embodied as a method implemented by a computer or a non-transitory computer readable medium in which computer executable instructions are stored. According to an embodiment, when executed by a processor, computer readable instructions may perform a method according to at least one aspect of the present disclosure.

The communication device 1020 may transmit or receive a wired signal or a wireless signal.

In addition, the method of training monotonic multi-label classification model according to the embodiment of the present invention may be implemented in the form of program instructions executable by various computer devices and may be recorded on computer readable media.

The computer readable media may be provided with program instructions, data files, data structures, and the like alone or in combination. The program instructions recorded on the computer readable media may be specially designed and constructed for the purposes of the present invention or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a DVD, magneto-optical media such as floptical disks, a ROM, a RAM, a flash memory, etc. The program instructions include not only machine language code made by a compiler but also high level code that may be used by an interpreter etc., which is executed by a computer.

The processor 110 is configured to execute computer-readable commands stored in the memory 130 or the storage device 140: to receive training data X; input the training data X into a monotonic multi-label classification model M1 based on a machine learning model to generate a prediction probability matrix Y for each of preset monotonic multi-labels; input a target value matrix T corresponding to the training data X and the prediction probability matrix Y into a predetermined distance loss function L_{DIST} to calculate a loss; and train the classification model M1 based on the loss.

The training data X may be emergency report information, and the multi-label may be an emergency code or a level of urgency expressed in a numerical value.

The distance loss function L_{DIST} is characterized by generating a weight to be multiplied by an error between a target value and a predicted probability based on the distance between a target label A(Ti) extracted from the target value matrix T and an index j of the monotonic multi-label.

The distance loss function L_{DIST} may be one of the above-described distance mean square loss function (L_{DiMS}, Equation 3), the absolute distance mean square loss function (L_{ADiMS}, Equation 4), the distance mean absolute loss function (L_{DiMA}, Equation 5), and the absolute distance mean absolute loss function (L_{ADiMA}, Equation 6).

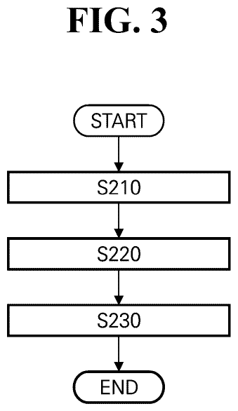

FIG. 3 is a flowchart for describing a method (hereinafter referred to as a “classification model training method”) of training a monotonic multi-label classification model according to an embodiment of the present invention. The classification model training method may be performed by the computer system 100 of FIG. 2.

Referring to FIG. 3, the method of training a monotonic multi-label classification model according to an embodiment of the present invention includes operations S210 to S230. The method of training a monotonic multi-label classification model shown in FIG. 3 is based on one embodiment, and operations of the method of training a monotonic multi-label classification model according to the present invention are not limited to the embodiment shown in FIG. 3, and some operations may be added, changed, or deleted as needed.

Operation S210 is an operation of receiving training data.

The computer system 100 receives training data X. The training data X may be emergency report information.

Operation S220 is an operation of calculating a predicted value and a loss.

The computer system 100 inputs the training data X into a monotonic multi-label classification model M1 based on a machine learning model to generate a predicted probability matrix Y for each of preset monotonic multi-labels. The multi-label may be an emergency code or a level of urgency expressed in a numeral value. The classification model M1 may be a machine learning model configured based on a decision tree model or an artificial neural network model.

The computer system 100 inputs a target value matrix T corresponding to the training data X and the prediction probability matrix Y into a predetermined distance loss function L_{DIST} to calculate a loss.

The distance loss function L_{DIST} is characterized by generating a weight to be multiplied by an error between a target value and a predicted probability based on the distance between a target label A(Tᵢ) extracted from the target value matrix T and an index j of the monotonic multi-label.

The distance loss function L_{DIST} may be one of the above-described distance mean square loss function (L_{DiMS}, Equation 3), the absolute distance mean square loss function (L_{ADiMS}, Equation 4), the distance mean absolute loss function (L_{DiMA}, Equation 5), and the absolute distance mean absolute loss function (L_{ADiMA}, Equation 6).

Operation S230 is an operation of training a classification model.

The computer system 100 trains the monotonic multi-label classification model M1 based on the loss calculated in operation S220.

The classification model training method has been described above with reference to the flowcharts presented in the drawings. While the above method has been shown and described as a series of blocks for the purpose of simplicity, it is to be understood that the present invention is not limited to the order of the blocks, and that some blocks may be executed in a different order from that shown and described herein or executed concurrently with other blocks, and various other branches, flow paths, and sequences of blocks that achieve the same or similar results may be implemented. In addition, not all illustrated blocks are necessarily required for implementation of the method described herein.

Meanwhile, in the description with reference to FIG. 3, each operation may be further divided into a larger number of operations or combined into a smaller number of operations according to examples of implementation of the present invention. In addition, some of the operations may not be performed or the order of operations may be changed as needed. In addition, even in the case of omitted content, the content of FIGS. 1 and 2 may be applied to the content of FIG. 3. In addition, the content of FIG. 3 may be applied to the content of FIGS. 1 and 2.

As is apparent from the above, according to the present invention, the performance of a model that classifies monotonic labels with stepwise sizes can be improved.

In addition, according to the present invention, the analysis accuracy for emergency reports can be improved, thereby providing relevant persons with response information appropriate for the level of urgency.

The effects of the present invention are not limited to those described above, and other effects that are not described above will be clearly understood by those skilled in the art from the above detailed description.

Although the present invention has been described in detail above with reference to exemplary embodiments, those of ordinary skill in the technical field to which the present invention pertains should be able to understand that various modifications and alterations may be made without departing from the technical spirit and scope of the present invention.

What is claimed is:

1. A method of training a monotonic multi-label classification model, the method comprising:
receiving, by a computer system including a memory in which computer-readable instructions are stored and at least one processor that is implemented to execute the instructions, training data;
inputting, by the computer system, the training data into a monotonic multi-label classification model based on a machine learning model to generate a prediction probability matrix for each of preset monotonic multi-labels;
inputting, by the computer system, a target value matrix corresponding to the training data and the prediction probability matrix into a predetermined distance loss function to calculate a loss; and
training, by the computer system, the monotonic multi-label classification model based on the loss,
wherein the distance loss function generates a weight to be multiplied by an error based on a distance between a target label extracted from the target value matrix and an index of the monotonic multi-label.

2. The method of claim 1, wherein the distance loss function is defined by the following equation:
$$L = \frac{1}{n l} {\sum }_{i = 1}^{n} {\sum }_{j = 1}^{l} {( \vert A ( {T}_{i} ) - j \vert + 1 )}^{2} {\vert {T}_{i j} - {Y}_{i j} \vert}^{2} , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

3. The method of claim 1, wherein the distance loss function is defined by the following equation:
$$L = \frac{1}{n l} {\sum }_{i = 1}^{n} {\sum }_{j = 1}^{l} ( \vert A ( {T}_{i} ) - j \vert + 1 ) {( {T}_{i j} - {Y}_{i j} )}^{2} , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

4. The method of claim 1, wherein the distance loss function is defined by the following equation:
$$L = \frac{1}{n l} {\sum }_{i = 1}^{n} {\sum }_{j = 1}^{l} {( \vert A ( {T}_{i} ) - j \vert + 1 )}^{2} \times \vert {T}_{i j} - {Y}_{i j} \vert , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

5. The method of claim 1, wherein the distance loss function is defined by the following equation:
$$L = \frac{1}{n l} {\sum }_{i = 1}^{n} {\sum }_{j = 1}^{l} ( \vert A ( {T}_{i} ) - j \vert + 1 ) \times \vert {T}_{i j} - {Y}_{i j} \vert , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

6. A computer system comprising:
a memory in which computer-readable instructions are stored; and
at least one processor implemented to execute the instructions,
wherein the at least one processor is configured to execute the instructions to:
input training data into a monotonic multi-label classification model based on a machine learning model to generate a prediction probability matrix for each of preset monotonic multi-labels;
input a target value matrix corresponding to the training data and the prediction probability matrix into a predetermined distance loss function to calculate a loss; and
train the monotonic multi-label classification model based on the loss,
wherein the distance loss function generates a weight to be multiplied by an error based on a distance between a target label extracted from the target value matrix and an index of the monotonic multi-label.

7. The computer system of claim 6, wherein the distance loss function is defined by the following equation:
$$L = \frac{1}{n l} {\sum }_{i = 1}^{n} {\sum }_{j = 1}^{l} {( \vert A ( {T}_{i} ) - j \vert + 1 )}^{2} {( {T}_{i j} - {Y}_{i j} )}^{2} , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein in the equation, L is a distance loss function, n is the number of training data, 1 is the number of monotonic multi-labels, i is an index of training data, j is an index of a monotonic multi-label, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

8. The computer system of claim 6, wherein the distance loss function is defined by the following equation:
$$L = \frac{1}{n l} {\sum }_{i = 1}^{n} {\sum }_{j = 1}^{l} ( \vert A ( {T}_{i} ) - j \vert + 1 ) {( {T}_{i j} - {Y}_{i j} )}^{2} , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-labels, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

9. The computer system of claim 6, wherein the distance loss function is defined by the following equation:
$$L = \frac{1}{n l} {\sum }_{i = 1}^{n} {\sum }_{j = 1}^{l} {( \vert A ( {T}_{i} ) - j \vert + 1 )}^{2} \times \vert {T}_{i j} - {Y}_{i j} \vert , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-labels, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.

10. The computer system of claim 6, wherein the distance loss function is defined by the following equation:
$$L = \frac{1}{n l} {\sum }_{i = 1}^{n} {\sum }_{j = 1}^{l} ( \vert A ( {T}_{i} ) - j \vert + 1 ) \times \vert {T}_{i j} - {Y}_{i j} \vert , \qquad [ Equation ]$$
$$A ( {T}_{i} ) = {arg max}_{k} {T}_{i k} = \{ k \vert {T}_{i k} = {max}_{1 \leq {k}^{′} \leq l} {T}_{{ik}^{′}} \}$$
wherein, in the equation, L is a distance loss function, n is the number of training data, 1 is the number of monotonic multi-labels, i is an index of training data, j is an index of a monotonic multi-labels, T is a target value matrix, Tᵢⱼ is a target value of a pair of the training data and the monotonic multi-label, Y is a prediction probability matrix, and Yᵢⱼ is a prediction probability calculated by the monotonic multi-label classification model for the pair of the training data and the monotonic multi-label.
